(19) United States
(12) Patent Application Publication
(10) Pub. No.: US 2011/0255958 A1
(43) Pub. Date: Oct. 20, 2011

(54) SEAL MEMBER FOR HOT GAS PATH COMPONENT

(75) Inventor: Thomas Raymond Farrell, Simpsonville, SC (US)

(73) Assignee: GENERAL ELECTRIC COMPANY, Schenectady, NY (US)

(21) Appl. No.: 12/761,658

(22) Filed: Apr. 16, 2010

(51) Int. Cl. F02C 7/28; F16J 15/02; F01D 11/00; F01D 5/02

(52) U.S. Cl. 415/170.1; 277/628

(57) ABSTRACT

A seal member for a hot gas path component in a gas turbine system is provided. The seal member includes a first seal pin, a second seal pin spaced from the first seal pin, and at least one cross-member. The at least one cross-member has a first end and a second end, and may be joined at the first end to the first seal pin and at the second end to the second seal pin. The at least one cross-member is configured to force the first and second seal pins apart when the seal member is subjected to a centrifugal force.

### FIELD OF THE INVENTION

The subject matter disclosed herein relates generally to hot gas path components, and more specifically to seal members for sealing hot gas path components.

### BACKGROUND OF THE INVENTION

Gas turbine systems are widely utilized in fields such as power generation. A conventional gas turbine system includes a compressor, a combustor, and a turbine. During operation of the gas turbine system, various components in the system are subjected to high temperature flows. Many of the components, known as hot gas path components, are disposed in annular arrays about an axis of the gas turbine system. Further, many of the components are positioned adjacent to other components, either in annular arrays or in other positions. For example, gas turbine blades and nozzles are positioned in annular arrays about a shaft. Frequently, gaps exist between adjacent components. These gaps may allow for leakage of the high temperature flows from the hot gas path, resulting in decreased performance, efficiency, and power output of the gas turbine system.

Further, since higher temperature flows generally result in increased performance, efficiency, and power output of the gas turbine system, the hot gas path components must be cooled to allow the gas turbine system to operate at increased temperatures. Various strategies are known in the art for cooling various gas turbine system components. For example, a cooling medium may be routed from the compressor and provided to various hot gas path components. However, the gaps between adjacent components may allow for the cooling medium to escape from the components and mix with the high temperature flows, resulting in further decreased performance, efficiency, and power output of the gas turbine system.

Various strategies are known in the art to prevent gas turbine system losses due to leakage and mixing. For example, seal pins have been utilized to seal the gaps between various adjacent hot gas path components, such as adjacent buckets. However, as the temperatures of hot gas path flows utilized in gas turbine systems are increased, and as hot gas path components are subjected to movement within the gas turbine system, these sealing mechanisms may no longer be effective to seal gaps and prevent leakages and mixing. For example, as adjacent hot gas path components move radially, circumferentially, and axially with respect to one another, or are subjected to high centrifugal forces due to rotation about a shaft, the seal pins within the hot gas path components may fail to respond properly to these movements and thus fail to effectively seal the gaps between the adjacent hot gas path components.

Thus, a seal member for sealing gaps in and between hot gas path components would be desired. Further, a seal member that responds to movements of the hot gas path components and maintains effective seals would be advantageous.

### BRIEF DESCRIPTION OF THE INVENTION

Aspects and advantages of the invention will be set forth in part in the following description, or may be obvious from the description, or may be learned through practice of the invention.

In one embodiment, a seal member for a hot gas path component in a gas turbine system is provided. The seal member includes a first seal pin, a second seal pin spaced from the first seal pin, and at least one cross-member. The at least one cross-member has a first end and a second end, and may be joined at the first end to the first seal pin and at the second end to the second seal pin. The at least one cross-member is configured to force the first and second seal pins apart when the seal member is subjected to a centrifugal force.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWING

A full and enabling disclosure of the present invention, including the best mode thereof, directed to one of ordinary skill in the art, is set forth in the specification, which makes reference to the appended figures, in which:

FIG. 1 is a schematic illustration of a gas turbine system;

FIG. 2 is a sectional side view of the turbine section of a gas turbine system according to one embodiment of the present disclosure;

FIG. 3 is a perspective view of a bucket assembly according to one embodiment of the present disclosure;

FIG. 4 is a plan view of a bucket assembly according to one embodiment of the present disclosure;

FIG. 5 is a plan view of a bucket assembly according to another embodiment of the present disclosure;

FIG. 6 is a cross-sectional view of a partial rotor assembly according to one embodiment of the present disclosure;

FIG. 7 is a cross-sectional view of a partial rotor assembly according to another embodiment of the present disclosure;

FIG. 8 is a cross-sectional view of a partial rotor assembly according to yet another embodiment of the present disclosure;

FIG. 9 is a plan view of a seal member according to one embodiment of the present disclosure;

FIG. 10 is a plan view of a seal member according to another embodiment of the present disclosure; and

FIG. 11 is a plan view of a seal member according to yet another embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

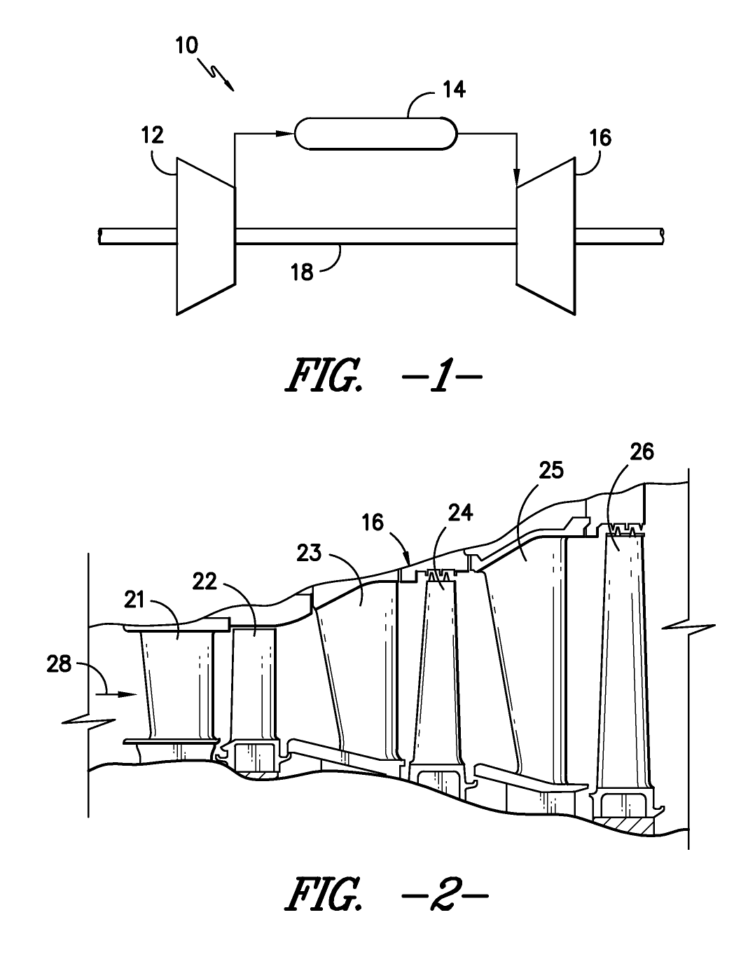

FIG. 1 is a schematic diagram of a gas turbine system 10. The system 10 may include a compressor 12, a combustor 14, and a turbine 16. Further, the system 10 may include a plurality of compressors 12, combustors 14, and turbines 16. The compressor 12 and turbine 16 may be coupled by a shaft 18. The shaft 18 may be a single shaft or a plurality of shaft segments coupled together to form a shaft 18.

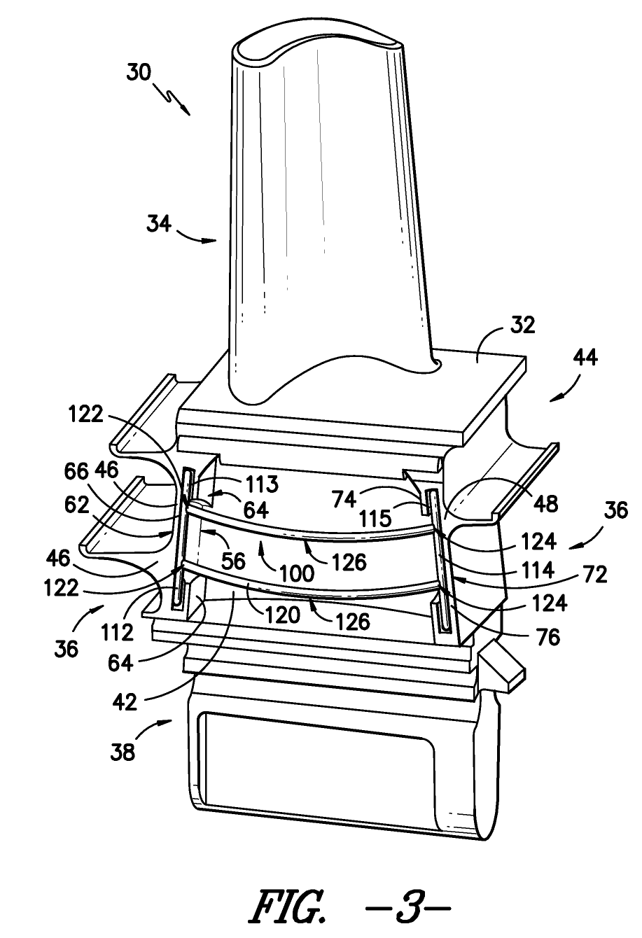

The turbine 16 may include a plurality of turbine stages. For example, in one embodiment, the turbine 16 may have three stages, as shown in FIG. 2. For example, a first stage of the turbine 16 may include a plurality of circumferentially spaced nozzles 21 and buckets 22. The nozzles 21 may be disposed and fixed circumferentially about the shaft 18. The buckets 22 may be disposed circumferentially about the shaft 18 and coupled to the shaft 18. A second stage of the turbine 16 may include a plurality of circumferentially spaced nozzles 23 and buckets 24. The nozzles 23 may be disposed and fixed circumferentially about the shaft 18. The buckets 24 may be disposed circumferentially about the shaft 18 and coupled to the shaft 18. A third stage of the turbine 16 may include a plurality of circumferentially spaced nozzles 25 and buckets 26. The nozzles 25 may be disposed and fixed circumferentially about the shaft 18. The buckets 26 may be disposed circumferentially about the shaft 18 and coupled to the shaft 18. The various stages of the turbine 16 may be disposed in the turbine 16 in the path of hot gas flow 28. It should be understood that the turbine 16 is not limited to three stages, but may have any number of stages known in the turbine art.

Each of the buckets 22, 24, 26 may comprise a bucket assembly 30, as shown in FIGS. 3 through 5. The bucket assembly 30 may include, for example, a platform 32, an airfoil 34, and a shank 36. The airfoil 34 may extend radially outward from the platform 32. The shank 36 may extend radially inward from the platform 32.

The bucket assembly 30 may further include a dovetail 38. The dovetail 38 may extend radially inward from the shank. In an exemplary aspect of an embodiment, the dovetail 38 may be configured to couple the bucket assembly 30 to the shaft 18. For example, the dovetail 38 may secure the bucket assembly 30 to a rotor disk (not shown) disposed on the shaft 18. A plurality of bucket assemblies 30 may thus be disposed circumferentially about the shaft 18 and coupled to the shaft 18, forming a rotor assembly 20.

The shank 36 may include a pressure side sidewall 42, a suction side sidewall 44, an upstream sidewall 46, and a downstream sidewall 48. The upstream sidewall 46 of the shank 36 may include an exterior surface 62, an interior surface 64, a pressure side surface 66, and a suction side surface 68. The downstream sidewall 48 of the shank 36 may include an exterior surface 72, an interior surface 74, a pressure side surface 76, and a suction side surface 78.

The upstream sidewall 46 and downstream sidewall 48, such as the interior surfaces 64 and 74, may define respective interior openings 56 and 58. The openings 56 and 58 may be provided to accommodate a seal member 100. For example, the openings 56 and 58 may be provided to allow a cross-member or cross-members 120 of a seal member 100 to be joined to and disposed generally between a first seal pin 112 and a second seal pin 114, as discussed in detail below.

The bucket assembly 30 may further include a seal member 100. The seal member 100 may be disposed generally within or adjacent to the shank 36. The seal member 100 may provide a seal between the bucket assembly 30 and an adjacent bucket assembly 30. For example, as shown in FIGS. 3 through 8, the seal member 100 may seal gaps 80 between the bucket assembly 30 and the adjacent bucket assembly 30. Further, upon the application of a centrifugal force 91 to the seal member 100, such as during operation of the system 10 causing rotation 90 of the bucket assemblies 30 about the shaft 18, the seal member 100 may provide additional sealing forces to the adjacent bucket assemblies, thereby enhancing the sealing of the gaps 80. By sealing the gaps 80, the seal member 100 may prevent the ingestion of hot gas flow 28 between and within the bucket assemblies 30. Further, the seal member 100 may prevent the escape of cooling flows from the bucket assemblies 30.

It should be understood, however, that while an exemplary embodiment of the seal member 100 may be utilized in a bucket assembly 30, the seal member 100 of the present disclosure is not limited to applications in bucket assemblies 30. For example, the seal member 100 of the present disclosure may be utilized with any component that is subject to rotational or centrifugal forces and that requires sealing of gaps within the component or between the component and an adjacent component.

The seal member 100 may include, for example, a first seal pin 112 and a second seal pin 114. The first seal pin 112 may be disposed adjacent the upstream sidewall 46. For example, in one embodiment, the first seal pin 112 may be disposed adjacent the suction side surface 68 of the upstream sidewall 46. Alternatively, the first seal pin 112 may be disposed adjacent the pressure side surface 66 of the upstream sidewall 46. Further, the first seal pin 112 may be disposed in a channel 113 defined in the upstream sidewall 46. In one embodiment, the channel 113 may be defined in the suction side surface 68 of the upstream sidewall 46. Alternatively, the first seal pin 112 may be defined in the pressure side surface 66 of the upstream sidewall 46.

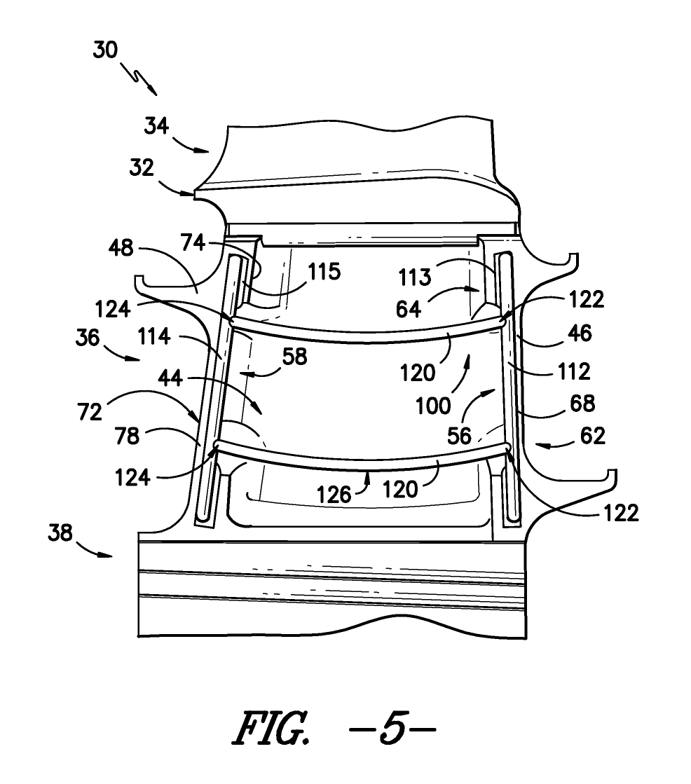

The first seal pin 112 may generally seal a gap 80 between adjacent bucket assemblies 30. For example, in one embodiment as shown in FIG. 5, the suction side surface 68 of the upstream sidewall 46 of a bucket assembly 30 may define a channel 113, while the pressure side surface 66 of the upstream sidewall 46 of the adjacent bucket assembly 30 may not define a channel 113. The first seal pin 112 may be disposed in the channel 113 defined in the bucket assembly 30 and adjacent the pressure side surface 66 of the adjacent bucket assembly 30, and may thus generally seal gap 80 between the bucket assembly 30 and adjacent bucket assembly 30.

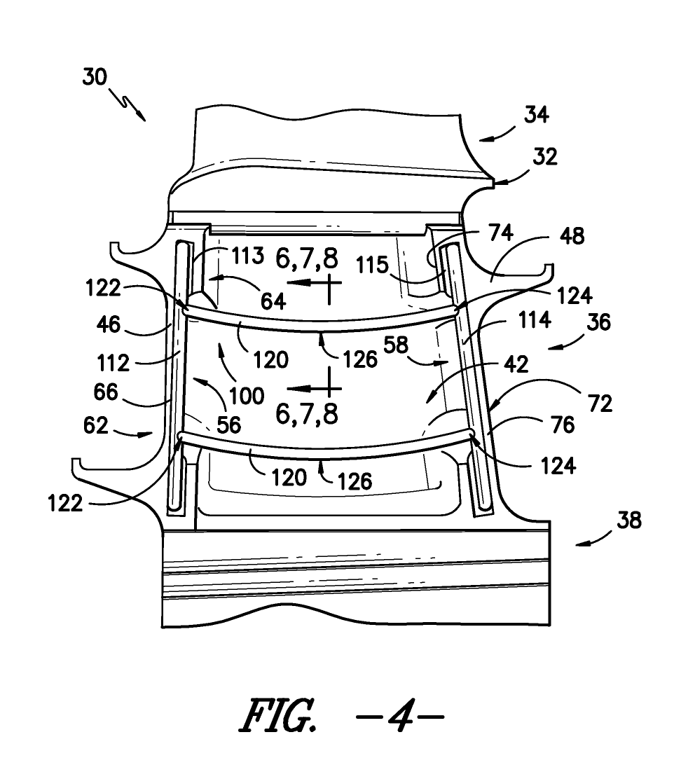

Alternatively, as shown in FIGS. 3 and 4, the pressure side surface 66 of the upstream sidewall 46 of a bucket assembly 30 may define the channel 113, while the suction side surface 68 of the upstream sidewall 46 of the adjacent bucket assembly 30 may not define a channel 113. The first seal pin 112 may be disposed in the channel 113 defined in the bucket assembly 30 and adjacent the suction side surface 68 of the adjacent bucket assembly 30, and may thus generally seal gap 80 between the bucket assembly 30 and adjacent bucket assembly 30.

Alternatively, the pressure side surface 66 of the upstream sidewall 46 of a bucket assembly 30 and the suction side surface 68 of the upstream sidewall 46 of the adjacent bucket assembly 30 may both define a channel 113, or the suction side surface 68 of the upstream sidewall 46 of a bucket assembly 30 and the pressure side surface 66 of the upstream sidewall 46 of the adjacent bucket assembly 30 may both define a channel 113. The first seal pin 112 may be disposed in the channels 113 defined in the bucket assemblies 30, and may thus generally seal gap 80 between the bucket assembly 30 and adjacent bucket assembly 30.

The second seal pin 114 may be disposed adjacent the downstream sidewall 48. For example, in one embodiment, the second seal pin 114 may be disposed adjacent the suction side surface 78 of the downstream sidewall 48. Alternatively, the second seal pin 114 may be disposed adjacent the pressure side surface 76 of the downstream sidewall 48. Further, the second seal pin 114 may be disposed in a channel 115 defined in the downstream sidewall 48. In one embodiment, the channel 115 may be defined in the suction side surface 78 of the downstream sidewall 48. Alternatively, the second seal pin 114 may be defined in the pressure side surface 76 of the downstream sidewall 48.

The second seal pin 114 may generally seal gap 80 between adjacent bucket assemblies 30. For example, in one embodiment as shown in FIG. 5, the suction side surface 78 of the downstream sidewall 48 of a bucket assembly 30 may define a channel 115, while the pressure side surface 76 of the downstream sidewall 48 of the adjacent bucket assembly 30 may not define a channel 115. The second seal pin 114 may be disposed in the channel 115 defined in the bucket assembly 30 and adjacent the pressure side surface 76 of the adjacent bucket assembly 30, and may thus generally seal gap 80 between the bucket assembly 30 and adjacent bucket assembly 30.

Alternatively, as shown in FIGS. 3 and 4, the pressure side surface 76 of the downstream sidewall 48 of a bucket assembly 30 may define a channel 115, while the suction side surface 78 of the downstream sidewall 48 of the adjacent bucket assembly 30 may not define a channel 115. The second seal pin 114 may be disposed in the channel 115 defined in the bucket assembly 30 and adjacent the suction side surface 78 of the adjacent bucket assembly 30, and may thus generally seal gap 80 between the bucket assembly 30 and adjacent bucket assembly 30.

Alternatively, the pressure side surface 76 of the downstream sidewall 48 of a bucket assembly 30 and the suction side surface 78 of the downstream sidewall 48 of the adjacent bucket assembly 30 may both define a channel 115, or the suction side surface 78 of the downstream sidewall 48 of a bucket assembly 30 and the pressure side surface 76 of the downstream sidewall 48 of the adjacent bucket assembly 30 may both define a channel 115. The second seal pin 114 may be disposed in the channels 115 defined in the bucket assemblies 30, and may thus generally seal gap 80 between the bucket assembly 30 and adjacent bucket assembly 30.

The seal member 100 may further include at least one cross-member 120. The cross-member 120 may have a first end 122 and a second end 124. The cross-member 120 may be joined at the first end 122 to the first seal pin 112 and at the second end 124 to the second seal pin 114. Further, the seal member 100 may include a plurality of cross-members 120, such as, for example, two cross-members 120, three cross-members 120, or any number of cross-members 120.

The cross-member 120 may be configured to force the first and second seal pins 112 and 114 apart when the seal member 100 is subjected to centrifugal force 91, as shown in FIGS. 6 through 8. For example, in an exemplary embodiment, the cross-member 120 may be generally arcuate. As shown in FIGS. 3 through 5, for example, the cross-member 120 included in bucket assembly 30 may extend radially inward and away from the platform 32 between the first seal pin 112 and the second seal pin 114. Further, the seal pins 112 and 114 may generally be positioned such that they extend radially towards each other, radially parallel with each other, or radially away from each other. The bucket assembly 30, and thus the seal member 100, may be subjected to centrifugal force 91 caused by the rotation 90 of the bucket assembly 30 about the shaft 18. The centrifugal force 91 may force the cross-member 120 radially outward towards the platform 32. As the cross-member 120 is forced radially outward, the cross-member 120 may force the first and second seal pins 112 and 114 apart, causing the first and second seal pins 112 and 114 to provide seals to the gaps 80.

Alternatively, the cross-member 120 may be generally straight and non-arcuate. Further, the seal pins 112 and 114 may generally be positioned such that they extend radially away from each other. For example, the seal pins 112 and 114 may generally be positioned in the shank 36 such that they extend away from one another as they extend radially through the shank 36 towards the platform 32. Thus, centrifugal force 91 may force cross-member 120 radially outward towards the platform 32, and cross-member 120 may thus force the first and second seal pins 112 and 114 apart, causing the first and second seal pins 112 and 114 to provide seals to the gaps 80.

In an exemplary embodiment, the first seal pin 112 and the second seal pin 114 may generally be coplanar. For example, the suction side surfaces 68 and 78 of the upstream sidewall 46 and downstream sidewall 48, respectively, or the pressure side surfaces 66 and 76 of the upstream sidewall 46 and downstream sidewall 48, respectively, or the channels 113 and 115, may be generally coplanar. The first and second seal pins 112 and 114 may be disposed adjacent the suction side surfaces 68 and 78 or the pressure side surfaces 66 and 76, or disposed within the channels 113 and 115, and may thus be generally coplanar.

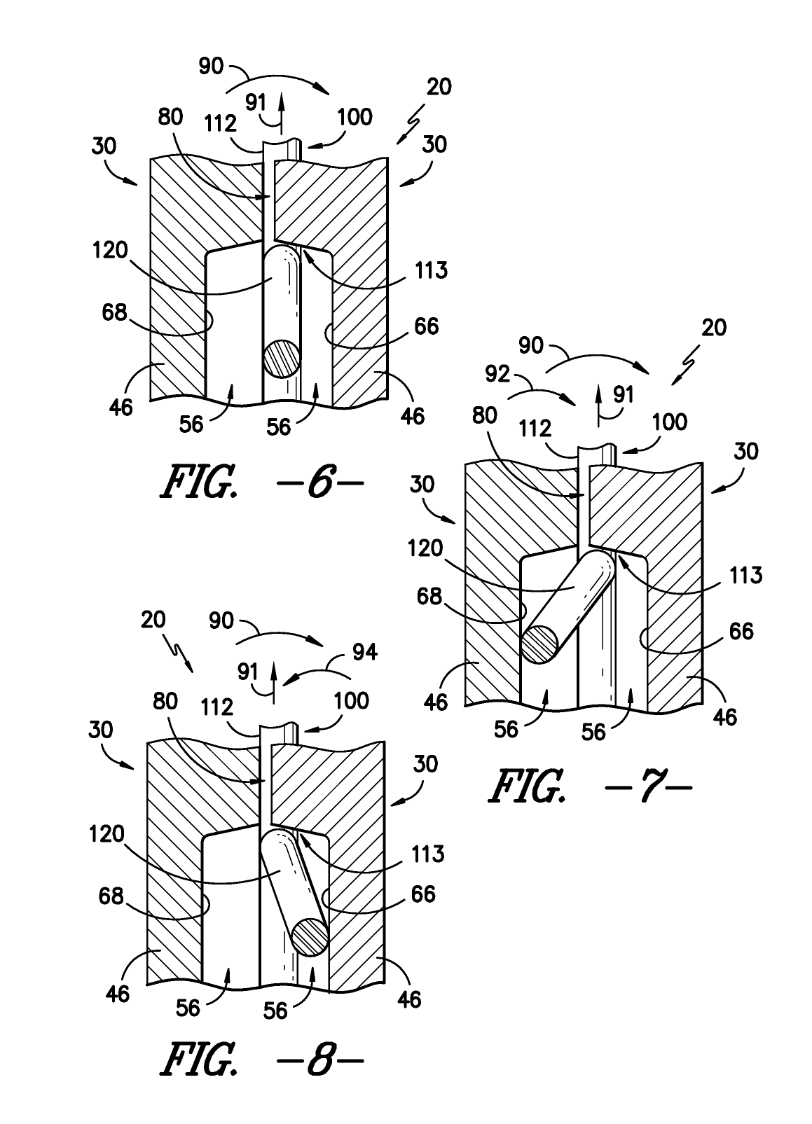

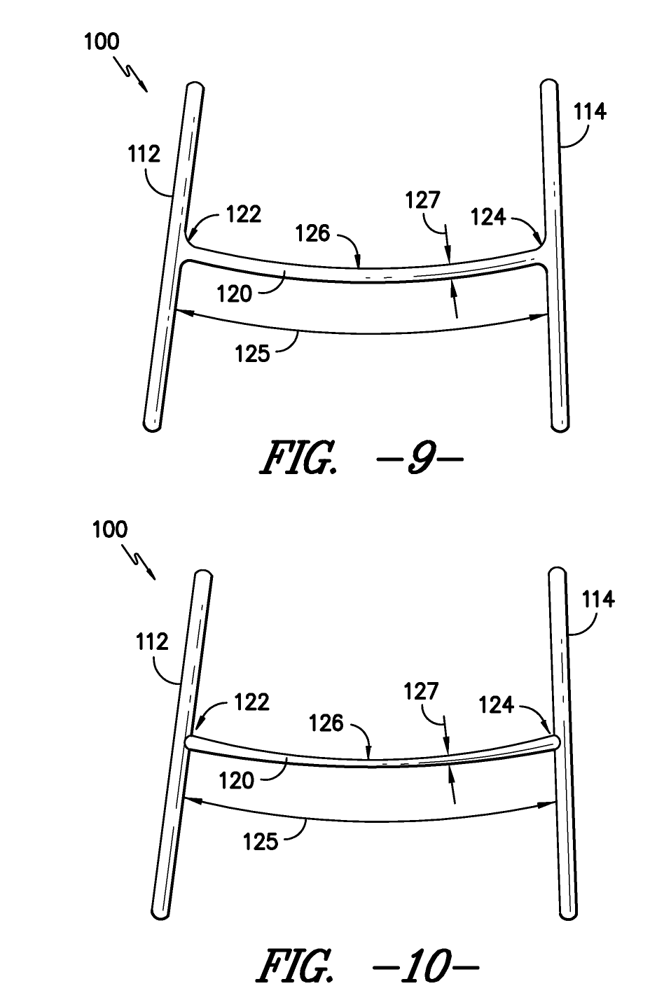

In an exemplary embodiment, the cross-member 120 may be generally co-planer with the first seal pin 112 and the second seal pin 114, as shown in FIG. 6. Alternatively, however, the cross-member 120 may be generally non-coplaner with the first seal pin 112 and the second seal pin 114, as shown in FIGS. 7 and 8.

For example, in one exemplary embodiment as shown in FIG. 7, the cross-member 120 may extend tangentially outward between the first pin 112 and the second pin 114. When the seal member 100 is included in a bucket assembly 30, for example, the cross-member 120 may extend tangentially outward from the shank 36 and towards an adjacent bucket assembly 30. When the seal member 100 is subjected to centrifugal force 91, such as, for example, when the seal member 100 is included in a bucket assembly 30 that is subjected to centrifugal force 91, the cross-member 120 may exert an inward offset moment 92 on the first seal pin 112 and the second seal pin 114. For example, when the seal member 100 is included in a bucket assembly 30, the cross-member 120 may force the first seal pin 112 and the second seal pin 114 towards the upstream sidewall 46 and downstream sidewall 48 of the bucket assembly 30. Further, for example, in the embodiment shown in FIG. 7, the cross-member 120 may force the first seal pin 112 and the second seal pin 114 towards the channels 113 and 115.

In another exemplary embodiment as shown in FIG. 8, the cross-member 120 may extend tangentially inward between the first pin 112 and the second pin 114. When the seal member 100 is included in a bucket assembly 30, for example, the cross-member 120 may extend tangentially inward towards the shank 36 and away from an adjacent bucket assembly 30. When the seal member 100 is subjected to centrifugal force 91, such as, for example, when the seal member 100 is included in a bucket assembly 30 that is subjected to centrifugal force 91, the cross-member 120 may exert an outward offset moment 94 on the first seal pin 112 and the second seal pin 114. For example, when the seal member 100 is included in a bucket assembly 30, the cross-member 120 may force the first seal pin 112 and the second seal pin 114 away from the upstream sidewall 46 and the downstream sidewall 48 of the bucket assembly 30 and towards the upstream sidewall 46 and the downstream sidewall 48 of an adjacent bucket assembly 30. Further, for example, in the embodiment shown in FIG. 8, the cross-member 120 may force the first seal pin 112 and the second seal pin 114 away from the channels 113 and 115.

It should be understood that the seal pins 112 and 114 and the cross-member 120 may have cross-sections with any geometric shape. For example, in one embodiment, the seal pins 112 and 114 and the cross-member 120 may have generally circular or oval cross-sections. Alternatively, the seal pins 112 and 114 and the cross-member 120 may have generally rectangular or square cross-sections. Alternatively, the seal pins 112 and 114 and the cross-member 120 may have generally triangular cross-sections, or may have cross-sections with any polygonal shape. Further, when the seal pins 112 and 114 and the cross-member 120 have generally circular or oval cross-sections, they may have diameters, such as diameter 127 of cross-member 120, discussed in detail below. Alternately, when the seal pins 112 and 114 and the cross-member 120 have generally rectangular, square, triangular, or polygonal cross-sections, they may have widths. Thus, for purposes of this disclosure, the term diameter may refer to a diameter of a generally circular or oval cross-section, or may refer to a width of any other cross-sectional shape.

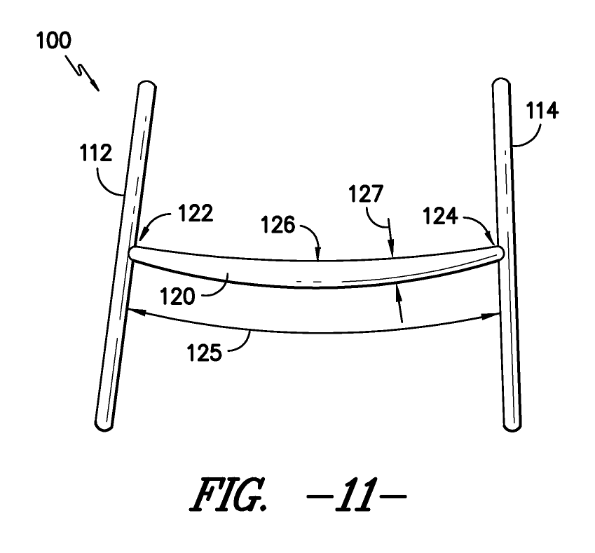

The cross-member 120 may generally have a length 125 and a diameter 127. In an exemplary embodiment, as shown in FIGS. 3, 4, 5 and 9, the diameter 127 may be generally constant throughout the length 125 of the cross-member 120. Alternatively, however, the diameter 127 may taper through the length 125 of the cross-member 120. For example, in one embodiment as shown in FIG. 10, the diameter 127 may be reduced through the length 125 of the cross-member 120 as the cross-member 120 extends away from the first seal pin 112 and the second seal pin 114. In this embodiment, midpoint 126 of the cross-member 120 between the first seal pin 112 and the second seal pin 114 may have a smaller diameter 127 than the first end 122 and the second end 124 of the cross-member 120. In another embodiment as shown in FIG. 11, the diameter 127 may be enlarged through the length 125 of the cross-member 120 as the cross-member 120 extends away from the first seal pin 112 and the second seal pin 114. In this embodiment, midpoint 126 of the cross-member 120 between the first seal pin 112 and the second seal pin 114 may have a larger diameter 127 than the first end 122 and the second end 124 of the cross-member 120.

It should further be understood that first end 122 and second end 124 need not have the same diameter 127, and that cross-member 120 may taper through the length 125 from the first end 122 to the second end 124. For example, the first end 122 may have a larger diameter 127 than the second end 124, or the second end 124 may have a larger diameter 127 than the first end 122. Further, the diameter 127 may be enlarged through the length 125 of the cross-member 120 from the first end 122 to the second end 124, or the diameter 127 may be reduced through the length 125 of the cross-member 120 from the first end 122 to the second end 124. Further, the diameter 127 of the cross-member 120 may taper or remain constant throughout any portion of the cross-member 120.

The first seal pin 112, the second seal pin 114, and the cross-member 120 may generally be formed of high temperature metal alloys or superalloys, or from any other suitable high temperature or high strength material. For example, in various embodiments, the alloys or superalloys may be nickel-, cobalt-, or steel-based, or may be any other metal or metal alloy or superalloy. In one exemplary embodiment, the first seal pin 112, the second seal pin 114, and the cross-member 120 may be a singular component. For example, the first seal pin 112, the second seal pin 114, and the cross-member 120 may be cast as a single piece. Alternatively, however, the first seal pin 112, the second seal pin 114, and the cross-member 120 may be separate components. Further, it should be understood that various of the components may be a singular component, while others may be separate.

Further, in an exemplary embodiment, the cross-member 120, such as the first end 122 and the second end 124, may be joined to the first seal pin 112 and the second seal pin 114. In one embodiment, as discussed above, the cross-member 120 may be joined to the first seal pin 112 and the second seal pin 114 by casting the cross-member 120, the first seal pin 112, and the second seal pin 114 as a singular component. Alternately, the cross-member 120 may be joined to the first seal pin 112 and the second seal pin 114 by any joining process, such as, for example, welding, brazing, soldering, adhesive bonding, diffusion bonding, or mechanical joining such as bolting. Further, in exemplary embodiments, the cross-member 120 may be joined to the first seal pin 112 and the second seal pin 114 through fillet joints as shown in FIG. 9, corner joints, tee joints, or any other joints or joining techniques.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A bucket assembly comprising:
a platform;
a shank extending radially inward from the platform, the shank including a pressure side sidewall, a suction side sidewall, an upstream sidewall, and a downstream sidewall;
a first seal pin disposed adjacent the upstream sidewall;
a second seal pin disposed adjacent the downstream sidewall; and
at least one cross-member having a first end and a second end, the at least one cross-member joined at the first end to the first seal pin and at the second end to the second seal pin,
wherein the at least one cross-member is configured to force the first and second seal pins apart when the bucket assembly is subjected to a centrifugal force, such that the first seal pin and the second seal pin provide a seal between the bucket assembly and an adjacent bucket assembly.

2. The bucket assembly of claim 1, wherein the at least one cross-member is generally arcuate.

3. The bucket assembly of claim 2, wherein the at least one cross-member extends radially inward and away from the platform between the first seal pin and the second seal pin.

4. The bucket assembly of claim 1, wherein the first seal pin and the second seal pin are generally coplanar.

5. The bucket assembly of claim 4, wherein the at least one cross-member is generally coplanar with the first seal pin and the second seal pin.

6. The bucket assembly of claim 4, wherein the at least one cross-member is generally non-coplanar with the first seal pin and the second seal pin.

7. The bucket assembly of claim 6, wherein the at least one cross-member extends tangentially outward from the shank between the first seal pin and the second seal pin.

8. The bucket assembly of claim 6, wherein the at least one cross-member extends tangentially inward towards the shank between the first seal pin and the second seal pin.

9. The bucket assembly of claim 1, wherein the at least one cross-member is a plurality of cross-members.

10. A seal member for a hot gas path component in a gas turbine system, the seal member comprising:
a first seal pin;
a second seal pin spaced from the first seal pin; and
at least one cross-member having a first end and a second end, the at least one cross-member joined at the first end to the first seal pin and at the second end to the second seal pin,
and wherein the at least one cross-member is configured to force the first and second seal pins apart when the seal member is subjected to a centrifugal force.

11. The seal member of claim 10, wherein the at least one cross-member is generally arcuate.

12. The seal member of claim 10, wherein the first seal pin and the second seal pin are generally coplanar.

13. The seal member of claim 12, wherein the at least one cross-member is generally coplanar with the first seal pin and the second seal pin.

14. The seal member of claim 12, wherein the at least one cross-member is generally non-coplanar with the first seal pin and the second seal pin.

15. The seal member of claim 10, wherein the at least one cross-member has a diameter and a length, and wherein the diameter is generally constant throughout the length of the at least one cross-member.

16. The seal member of claim 10, wherein the at least one cross-member has a diameter and a length, and wherein the diameter tapers through the length of the at least one cross-member.

17. The seal member of claim 10, wherein the first seal pin, the second seal pin, and the at least one cross-member are a singular component.

18. The seal member of claim 10, wherein the first seal pin, the second seal pin, and the at least one cross-member are separate components.

19. The seal member of claim 10, wherein the at least one cross-member is joined to the first seal pin and the second seal pin through one of fillet joints, corner joints, or tee joints.

20. The seal member of claim 10, wherein the at least one cross-member is a plurality of cross-members.
